(19) United States
(12) Patent Application Publication
(10) Pub. No.: US 2002/0076132 A1
(43) Pub. Date: Jun. 20, 2002

(54) Optical filter for simultaneous single sideband modulation and wavelength stabilization

(76) Inventors: Eva M. Peral, Pasadena, CA (US); Israel Ury, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/738,404

(22) Filed: Dec. 15, 2000

(51) Int. Cl. G02B 6/26

(52) U.S. Cl. 385/15; 385/27

(57) ABSTRACT

An exemplary embodiment of the present invention includes a laser control system that simultaneously provides single sideband modulation of the light emitted by a directly modulated laser to reduce fiber dispersion alongwith feedback control to stabilize the laser wavelength at a predetermined transmission wavelength λ₀.

### BACKGROUND

Optical fiber communication systems provide for low loss and very high information carrying capacity. In practice, the bandwidth of optical fiber may be utilized by transmitting many distinct channels simultaneously using different carrier wavelengths. The associated technology is called wavelength division multiplexing (WDM). In WDM (Wavelength Division Multiplexed) networks, the wavelength of an optical signal is used to direct the signal from its source to its destination. Each network user typically has a laser source operating at a specific wavelength which is different from those of other laser sources.

Some laser sources, for example distributed feedback (DFB) lasers, exhibit wavelength drift over time, in excess of the requirements for narrow band WDM. The wavelength of the device tends to change with aging under continuous power. Various techniques are used to stabilize the bias current and temperature of the laser diode to accommodate wavelength drift with age and temperature. However, conventional bias current and temperature stabilization techniques are inadequate for the stringent requirements for many optical systems, such as WDM networks. Therefore, the channel spacing must be sized to ensure that the individual channels do not overlap over time, thereby reducing the maximum achievable bandwidth of the WDM system.

In addition, material and waveguide dispersion effects that cause pulse broadening may also limit the maximum transmission bandwidth of an optical communication system. Most of the installed fibers have zero dispersion at 1.3 microns but minimum loss at 1.55 microns, where the group velocity dispersion is significant, typically on the order of about −17 ps/(nm.km). Because of dispersion, the different spectral components of the transmitted signal propagate at different velocities. When the difference in the propagation delays for the maximum and minimum optical frequencies becomes comparable to the period of the highest RF frequency being transmitted, the response at the higher RF frequencies will be significantly suppressed. This limits the bit rate and distance over which data can be reliably communicated because it determines how closely input pulses can be spaced without overlap at the output end. For example, at 2.5 Gbit/s for long distance transmission, above about 100 km, fiber dispersion necessitates the use of external modulators instead of directly modulated semiconductor lasers.

Therefore it would be advantageous to provide a dispersion resistant wavelength stabilization system for use in electro-optic communication systems.

### SUMMARY OF THE INVENTION

In one aspect of the present invention, an optical system for transmitting optical signals in a fiber includes a beam splitter for generating a reflected optical signal and a transmit optical signal from incident light, a filter adapted to receive the transmit optical signal and to suppress at least a portion of one sideband of the transmit optical signal to reduce fiber dispersion, and a wavelength stabilization circuit that stabilizes the wavelength of the filtered optical signal in accordance with a characteristic of the reflected optical signal and filtered optical signal.

In another aspect of the present invention an optical system for transmitting optical signals in a fiber includes an electro-optic transmitter whose output is coupled to a beam splitter. The beam splitter generates a reflected optical signal and a transmit optical signal from the output of the electro-optic transmitter. The optical system further includes a filter adapted to receive the transmit optical signal and suppress at least a portion of one sideband of the transmit optical signal to reduce fiber dispersion, and a wavelength stabilization circuit that stabilizes the wavelength of the filtered optical signal in accordance with a characteristic of the reflected optical signal and filtered optical signal.

In another aspect of the present invention a method for transmitting an optical signal in a fiber includes directly modulating an electro-optic transmitter to produce a laser output signal, generating a reflected optical signal and a transmit optical signal from the laser output signal, suppressing at least a portion of one sideband of said transmit optical signal to produce a sideband modulated signal, determining the power level of the reflected optical signal and said sideband modulated signal, generating a laser feedback signal in accordance with the ratio of the power of the reflected optical signal divided by the power of the sideband modulated signal and stabilizing the wavelength of the laser output signal in accordance with the laser feedback signal.

### BRIEF DESCRIPTION OF THE DRAWINGS

These and other features, aspects, and advantages of the present invention will become better understood with regard to the following description, appended claims, and accompanying drawings, in which:

FIG. 1 is a simplified block diagram of a laser control system in accordance with an exemplary embodiment of the present invention;

FIG. 2a-c are graphical illustrations of a filter transfer function providing single sideband modulation in accordance with an exemplary embodiment of the present invention;

FIG. 3 is a graphical illustration of the transmission coefficient versus wavelength of a fiber Bragg grating for providing single sideband modulation in accordance with an exemplary embodiment of the present invention;

FIG. 4 is a graphical illustration of the bit error rate versus wavelength for a directly modulated DFB whose output is filtered to provide single side band modulation as in FIG. 3 in accordance with an exemplary embodiment of the present invention;

FIG. 5 is a graphical illustration of the power ratio versus wavelength for a directly modulated DFB whose output is filtered to provide single side band modulation as in FIG. 3 in accordance with an exemplary embodiment of the present invention; and

FIG. 6 is flow diagram demonstrating the operation of a laser control system having single sideband modulation and wavelength stabilization in accordance with an exemplary embodiment of the present invention.

### DETAILED DESCRIPTION OF THE INVENTION

An exemplary embodiment of the present invention reduces fiber dispersion degradation in an optical communication system having wavelength stabilization. Optical fiber communication is a very important form of telecommunication. An optical communication system consists of a transmitter, a transmission medium, and a receiver. In operation the information to be communicated may be directly or externally modulated onto the transmit optical beam. A currently preferred optical communications system intensity modulates (IM) the optical carrier with an information carrying electrical signal and directly detects (DD) the transmitted signal with a photodetector. The photodector converts the optical signal back to the original electrical format. Alternatively, information may also be transmitted in the frequency or the phase of the optical signal. However, frequency modulation systems require the use of homodyne or heterodyne detection techniques. Although this scheme, known as coherent transmission, offers better theoretical sensitivity, it has been largely superseded by intensity-modulation direct-detection (IM/DD) systems due to their simplicity and better overall performance.

Generally, there are two schemes to intensity modulate the light produced by a semiconductor laser. First, the drive current of a semiconductor laser may be varied to directly modulate the laser at a relatively high speed. This modulation scheme, referred to as direct-modulation, is relatively simple to implement and provides relatively wide bandwidth. However, variations in the drive current not only modulate the intensity of the light, but also modulate the optical frequency. This frequency modulation, also known as laser “chirp”, may degrade the transmitted signal when the optical communication channel is dispersive. As a consequence of dispersion, part of the frequency modulation (FM) is converted into intensity modulation (IM). This FM-to-IM conversion may result in signal distortion, that is manifested as, for example, pulse broadening for digital signals.

The second modulation method utilizes chirp-free external modulators, such as for example, electro-optic Mach-Zehnder modulators, to reduce fiber dispersion effects. However, external modulators may introduce large optical losses due to inefficient coupling to the modulator and waveguide losses. In addition, external modulators may also increase the cost of the communication system.

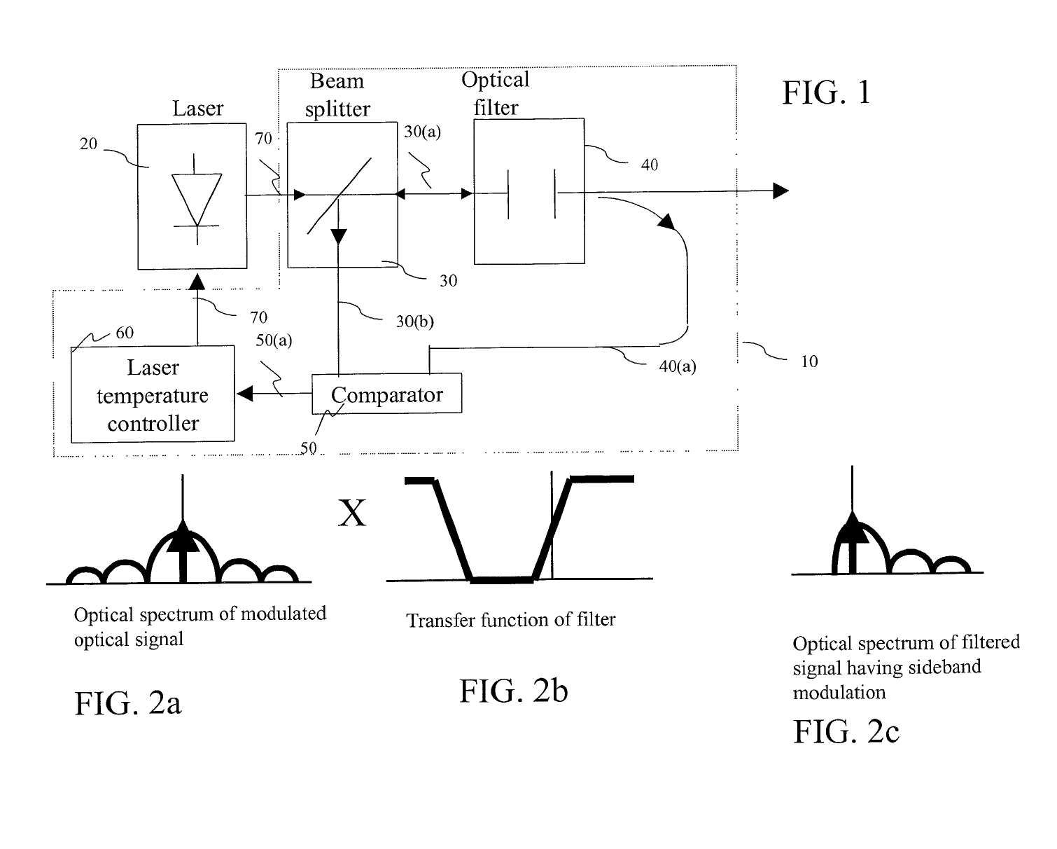

Therefore, an exemplary embodiment of the present invention, as shown in the simplified block diagram of FIG. 1, includes a laser control system 10 that simultaneously provides single sideband modulation of the light emitted by laser 20 to reduce fiber dispersion alongwith feedback control to stabilize the laser wavelength at a predetermined transmission wavelength λ₀. The present invention, therefore allows for the use of directly modulated lasers in a dispersive environment. One of skill in the art will appreciate that the present invention may be used to stabilize the wavelength of numerous types of lasers such as distributed feedback (DFB) lasers, edge emitters, vertical cavity surface emitting lasers, or other lasers known in the art.

In an exemplary embodiment of the present invention, the laser control system 10 includes a beam splitter 30; an optical filter 40, a comparator 50 and a laser temperature controller 60. Light emitted by laser 20 is transmitted by an optical fiber 70 or other suitable medium to the beam splitter 30 where it is divided into a laser output beam 30(a) that is forwarded to the optical filter 40 and a reflected laser sample beam transmitted by optical fiber 30(b) or other suitable medium to a first port of the comparator 50. The laser output beam is incident upon optical filter 40. The transmission coefficients of the optical filter vary with wavelength so that the optical filter selectively transmits/reflects the laser output beam 30(a), depending upon the wavelength of the laser emission.

In the described exemplary embodiment, the optical filter 40 may be an optical fiber grating filter, but may also take alternative forms such as for example, an etalon depending on the desired frequency selectivity. Filtered laser output beam 40(a) is transmitted by optical fiber or other suitable medium to a second port of comparator 50. In addition, light reflected by optical filter 40, is transmitted back through fiber 30(a) to beam splitter 30, and then directed via optical fiber 30(b) to the first port 50(a) of comparator 50. Comparator 50 generates a laser temperature feedback signal 50(a). The temperature feedback signal is coupled to the laser temperature controller 60 for adjusting the output wavelength of laser 20.

The comparator ports preferably include electro-optic photodetectors (not shown) that receive the filtered laser output signal and reflected signal respectively, and convert the received optical signals into voltage signals. In the described exemplary embodiment, comparator 50 may include an analog circuit or analog devices, such as a balanced operational amplifier (not shown) that compares the filtered laser output signal 40(a) and the reflected signal 30(b). The analog device may generate a laser temperature feedback signal 50(c), in accordance with the ratio of the power of the reflected signal and the power of the filtered laser output signal.

The laser temperature feedback signal 50(a) is applied to the set point input of temperature controller 60. The temperature controller 60 uses the laser temperature feedback signal to generate a laser current feedback signal 70 for setting the output wavelength of laser 20 at the desired value. In the described exemplary embodiment the photodetectors may be selected as a matched pair, so that the output of the operational amplifier is independent of the spectral characteristics of the photodetectors, depending only upon the emission wavelength of the semi-conductor laser device.

The optical filter, may be designed as a side-band filter, suppressing at least part of one of the side bands of the modulated optical carrier to reduce the effect of group velocity dispersion in the optical fiber. For example, referring to FIG. 2, in an exemplary embodiment of the present invention, the transfer function (FIG. 2b) of the optical filter 40 provides single sideband modulation of the laser output (illustratively shown in FIG. 2a). Therefore, as shown in FIG. 2c the optical spectrum of the filtered laser output signal takes the form of a vestigial single sideband modulation.

The optical filter 40 may be implemented as a fiber grating. A fiber grating, or more precisely, a fiber Bragg grating, as is known in the art, is created by a periodic change in the effective refractive index of an optical fiber. Bragg gratings are typically formed holographically, by exposing a germanium-containing fiber to ultraviolet light through a phase mask. Alternatively, optical filter 40 may take the form of an etalon if reduced frequency selectivity is acceptable and packaging size is of concern.

The design of an optimum filter transfer function to reduce fiber dispersion effects is dependent upon a plurality of system parameters. However, the laser large-signal intensity and frequency modulation response for a given filter design may be either measured using a digital sampling scope or simulated using the laser rate equations. The detected signal at the fiber end will be given by equation (1):

Iₒᵤₜ(t)=|ℑ⁻¹(Eᵢₙ(f)H_{fiber}(f)H_{fiber}(f) (1)

where ℑ⁻¹ indicates inverse Fourier transform, Eᵢₙ(f) is the electric field at the laser output, and H_{filter}(f) and H_{fiber}(f) are the transfer functions of the filter and the fiber, respectively.

The fiber transfer function is well known in the art and depends on known fiber parameters and the fiber length. The filter transfer function may be measured for a particular filter using a network analyzer. The center wavelength of a particular filter may be optimized to reduce fiber dispersion effects when utilized with a particular laser in a given optical transmission system by computing the detected current, Iₒᵤₜ(t), as a function of the center frequency of the filter. The detected current may then be used to evaluate system performance parameters such as eye aperture or bit error rate (BER). This analysis may also be used to help design the filter by evaluating the performance of different filters. One of skill in the art will appreciate that the detected current will be dependent on the laser frequency modulation or chirp. Further, acceptable bit error rate levels or other measures of performance may vary depending upon the type of information being transmitted.

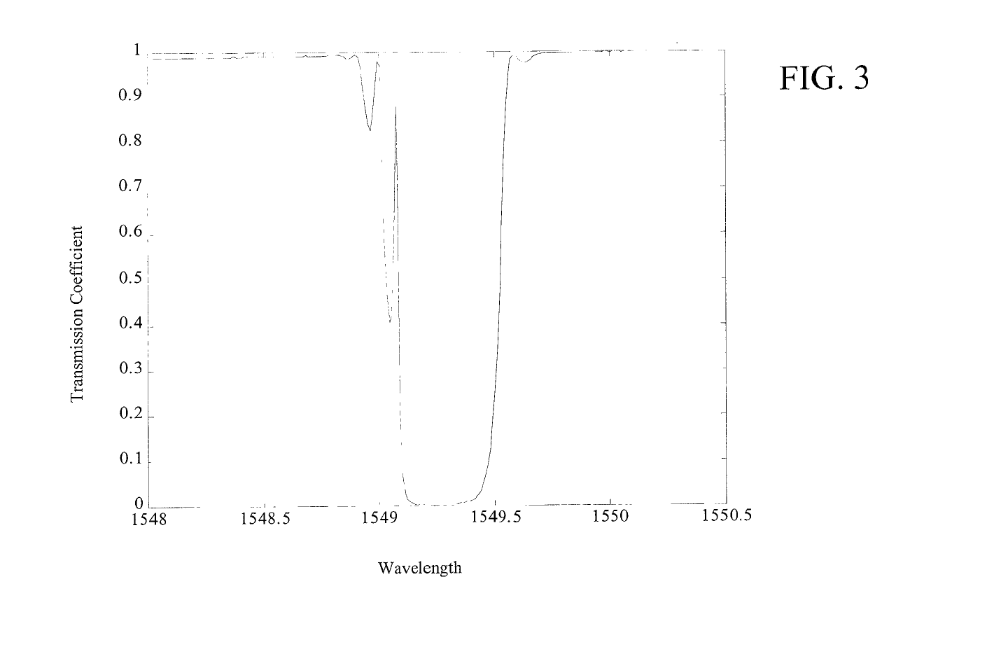

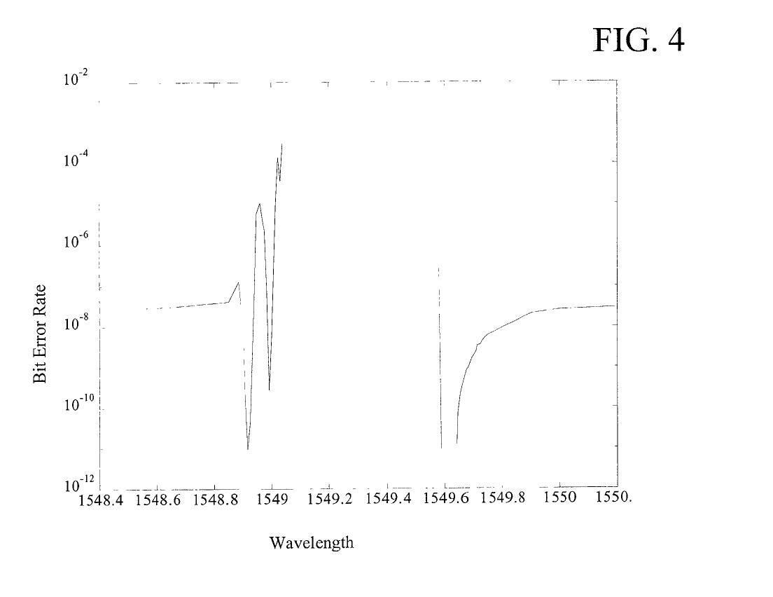

For example, referring to FIG. 3, the transfer coefficient of a uniform fiber Bragg grating is plotted as a function of wavelength. The filter was driven by a directly modulated DFB laser with an optimum operating point of 1549.59 nm. FIG. 4 shows the bit error rate as a function of wavelength for a directly modulated DFB laser driving the filter of FIG. 3. The bit error rate without the filter is on the order of 3×10⁻⁸. However, as the laser wavelength approaches the grating edge at approximately 1549.2 nm, the bit error rate is greatly improved.

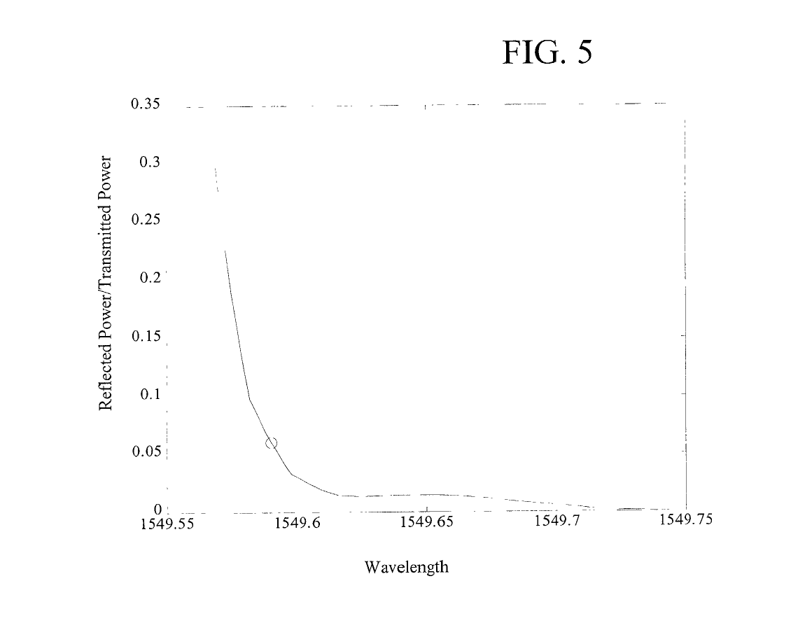

In operation, the wavelength of the transmitted light may be characterized as a function of the ratio of the reflected and transmitted powers, allowing for the identification of an optimum temperature operating point. The optimum wavelength for a particular communication system will depend on filter shape and laser operating parameters, that may be tuned by adjusting the temperature of the laser. During normal operation, the temperature of the laser may be adjusted so as to maintain the optimum power ratio. For example, FIG. 5 graphically illustrates the wavelength versus power ratio for a directly modulated MQW-DFB laser using a fiber Bragg grating with a transmission coefficient as shown in FIG. 3. In this example the desired operating point is a 1549.50 nm.

Therefore, during initial calibration, the optimum operating wavelength of the laser may be mathematically determined in accordance with Eq. (1) or experimentally determined using a bit error rate tester. The ratio of the reflected power and transmitted power at the optimum operating point may then be determined. The temperature performance of the laser may then be characterized as a function of reflected and transmitted power over a sufficient frequency range to encompass the expected drift in the laser or filter wavelength. In this instance the transmitted wavelength shifts approximately 0.8 nm/° C. The described exemplary temperature controller may then utilize the variance between the optimum power ratio and actual power ratio to control the temperature of the laser and maintain a constant wavelength. In a preferred embodiment of the present invention, temperature controller 60 may interpret a positive error signal as requiring a decrease in current on line 70.

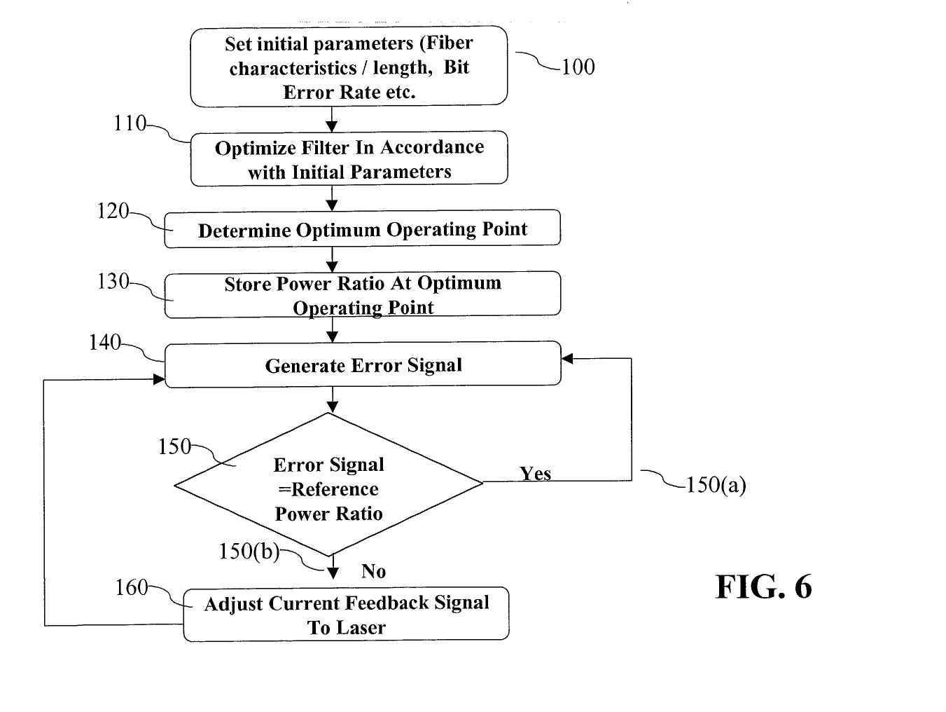

Referring to FIG. 6, the single optical filter element 40 of FIG. 1 may be used to reduce fiber dispersion effects and to provide wavelength stabilization of the transmitted optical signal. Initially, a user of a given optical communication system may establish a set of design parameters such as for example fiber type, length, acceptable bit error rate etc. 100. An optical filter, such as for example a fiber Bragg grating may then be designed in accordance with the various initial design parameters 110. Filter performance may be verified in accordance with the detected output current in accordance with Eq. (1) or measured by a simple series of bench-top experiments.

When the optical filter has been fully characterized, a series of bit error rate tests may be performed to determine the optimum operating point for that filter/laser combination 120. In the described exemplary embodiment the ratio of the power of the reflected signal and filtered output signal may then be stored as a reference point for a feedback control loop 130. One of skill in the art will appreciate that various other characteristics of the reflected and filtered signals may also be used as a reference point for the feedback control.

During the operation of the control system of FIG. 1, the comparator receives the reflected signal and filtered output signal and computes the intensity or power level of each. The comparator may then generate the ratio of the power of the reflected signal and the power of the filtered output signal. The temperature controller may compute an error signal representing the difference between the optimum power ratio and the actual power ratio 140. A control feedback loop may then be used to adjust the laser current feedback signal 160 when the actual power ratio of the received reflected signal and filtered signal does not equal the optimum power ratio 150.

Although a preferred embodiment of the present invention has been described, it should not be construed to limit the scope of the appended claims. Those skilled in the art will understand that various modifications may be made to the described embodiment. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

What is claimed is:

1. An optical system for transmitting optical signals in a fiber, comprising:
a beam splitter for generating a reflected optical signal and a transmit optical signal from incident light;
a filter adapted to receive said transmit optical signal, wherein said filter suppresses at least a portion of one sideband of said transmit optical signal to reduce fiber dispersion; and
a wavelength stabilization circuit that stabilizes the wavelength of filtered optical signal in accordance with a characteristic of said reflected optical signal and filtered optical signal.

2. The optical system of claim 1 wherein said wavelength stabilization circuit comprises a comparator, adapted to receive said reflected optical signal and at least a portion of the filtered optical signal, for generating a laser feedback signal in accordance with a characteristic of said reflected optical signal and filtered optical signal, and a temperature controller for adjusting operating temperature of said laser as a function of said laser feedback signal.

3. The optical system of claim 2 wherein said comparator comprises a first photodetector that receives said reflected optical signal and converts said received reflected optical signal to a first electrical signal and a second photodetector that receives said filtered optical signal and converts said received filtered optical signal to a second electrical signal, wherein said comparator generates said laser feedback signal in accordance with a characteristic of said first and second electrical signals.

4. The optical system of claim 3 wherein said comparator further comprises one or more power meters that measure the power of said first and second electrical signals, wherein said comparator generates said laser feedback signal in accordance with ratio of power of said first electrical signal divided by power of said second electrical signal.

5. The optical system of claim 1 wherein said filter comprises a fiber Bragg grating.

6. The optical system of claim 1 wherein said filter comprises a etalon.

7. An optical system for transmitting optical signals in a fiber, comprising:
a beam splitter for generating a reflected optical signal and a transmit optical signal from incident light;
a filter adapted to receive said transmit optical signal, wherein said filter suppresses at least a portion of one sideband of said transmit optical signal to reduce fiber dispersion; and
a wavelength stabilization circuit that stabilizes the wavelength of filtered optical signal in accordance with power of said reflected optical signal and filtered optical signal.

8. The optical system of claim 7 wherein said wavelength stabilization circuit comprises a comparator, adapted to receive said reflected optical signal and at least a portion of the filtered optical signal, for generating a laser feedback signal in accordance with the power of said reflected optical signal and filtered optical signal, and a temperature controller for adjusting operating temperature of said laser as a function of said laser feedback signal.

9. An optical system for transmitting optical signals in a fiber, comprising:
an electro-optic transmitter;
a beam splitter coupled to said electro-optic transmitter for generating a reflected optical signal and a transmit optical signal from output of said electro-optic transmitter;
a filter adapted to receive said transmit optical signal, wherein said filter suppresses at least a portion of one sideband of said transmit optical signal to reduce fiber dispersion; and
a wavelength stabilization circuit that stabilizes the wavelength of filtered optical signal in accordance with a characteristic of said reflected optical signal and filtered optical signal.

10. The optical communication system of claim 9 wherein said electro-optic transmitter comprises a DFB laser.

11. The optical communication system of claim 10 wherein an information carrying signal intensity modulates said DFB laser.

12. The laser control system of claim 11 wherein said wavelength stabilization circuit comprises a comparator, adapted to receive said reflected optical signal and at least a portion of the filtered optical signal, for generating a laser feedback signal in accordance with a characteristic of said reflected optical signal and filtered optical signal, and a temperature controller for adjusting operating temperature of said laser as a function of said laser feedback signal.

13. The optical communication system of claim 9 wherein said electro-optic transmitter comprises an edge emitter.

14. The optical communication system of claim 9 wherein said electro-optic transmitter comprises a vertical cavity surface emitting laser.

15. The laser control system of claim 9 wherein said filter comprises a fiber Bragg grating.

16. The laser control system of claim 9 wherein said filter comprises a etalon.

17. A method for transmitting an optical signal in a fiber comprising:
generating a reflected optical signal and a transmit optical signal from a laser output signal;
suppressing at least a portion of one sideband of said transmit optical signal to produce a sideband modulated signal;
generating a laser feedback signal in accordance with a characteristic of said sideband modulated signal and said reflected optical signal; and
stabilizing wavelength of said laser output signal in accordance with said laser feedback signal.

18. The method of claim 17 further comprising determining power level of said sideband modulated signal and said reflected optical signal and wherein said laser feedback signal is generated in accordance with actual ratio of power of said reflected optical signal divided by power of said sideband modulated signal.

19. The method of claim 18 further comprising determining optimum power ratio of said reflected optical signal divided by power of said sideband modulated signal at desired wavelength of laser output signal, and wherein said laser feedback signal is generated in accordance with difference between optimum power ratio and actual power ratio.

20. A method for transmitting an optical signal in a fiber, comprising:
directly modulating an electro-optic transmitter to produce a laser output signal;
generating a reflected optical signal and a transmit optical signal from said laser output signal;
suppressing at least a portion of one sideband of said transmit optical signal to produce a sideband modulated signal;
determining power level of said reflected optical signal and said sideband modulated signal;
generating a laser feedback signal in accordance with actual ratio of power of said reflected optical signal divided by power of said sideband modulated signal; and
stabilizing wavelength of said laser output signal in accordance with said laser feedback signal.

21. The method of claim 20 further comprising determining optimum ratio of the power of said reflected optical signal divided by the power of said sideband modulated signal at desired wavelength of laser output signal, and wherein said laser feedback signal is generated in accordance with difference between optimum power ratio and actual power ratio.
